(19) United States
(12) Patent Application Publication
(10) Pub. No.: US 2012/0156475 A1
(43) Pub. Date: Jun. 21, 2012

(54) MAGNESIUM ALLOY ARTICLE AND METHOD FOR MAKING THE SAME

(75) Inventors: HSIN-PEI CHANG, Tu-Cheng (TW); WEN-RONG CHEN, Tu-Cheng (TW); HUANN-WU CHIANG, Tu-Cheng (TW); CHENG-SHI CHEN, Tu-Cheng (TW); DUN MAO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/094,996

(22) Filed: Apr. 27, 2011

(30) Foreign Application Priority Data
Dec. 16, 2010 (CN) 201010592384.2

(51) Int. Cl. B32B 3/00; C23F 1/00; B05D 3/10; B32B 15/04; B05D 1/36

(52) U.S. Cl. 428/336; 428/472; 427/402; 427/327; 216/37

(57) ABSTRACT

A magnesium alloy article includes a base made of magnesium alloy, a coating layer formed on the base, and an intermediate layer formed between the base and the coating layer. The intermediate layer is a mixture of component mainly including Mg, Al, O, P, Mn. The disclosure also described a method to make the housing.

### BACKGROUND

1. Technical Field

The present disclosure relates to magnesium alloy articles and a method for making the same.

2. Description of the Related Art

Magnesium alloy articles generally includes a magnesium alloy base and a coating. The coating can be formed on the magnesium alloy base by physical vapor deposition (PVD). However, the yielded coating by PVD often produces needle-like holes in the exterior coating surface, badly influencing erosion resistance and abrasion resistance.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a sectional schematic view of a magnesium alloy article according to an exemplary embodiment.

FIG. 2 is a structural schematic view of a coating machine for fabricating the magnesium alloy article.

### DETAILED DESCRIPTION

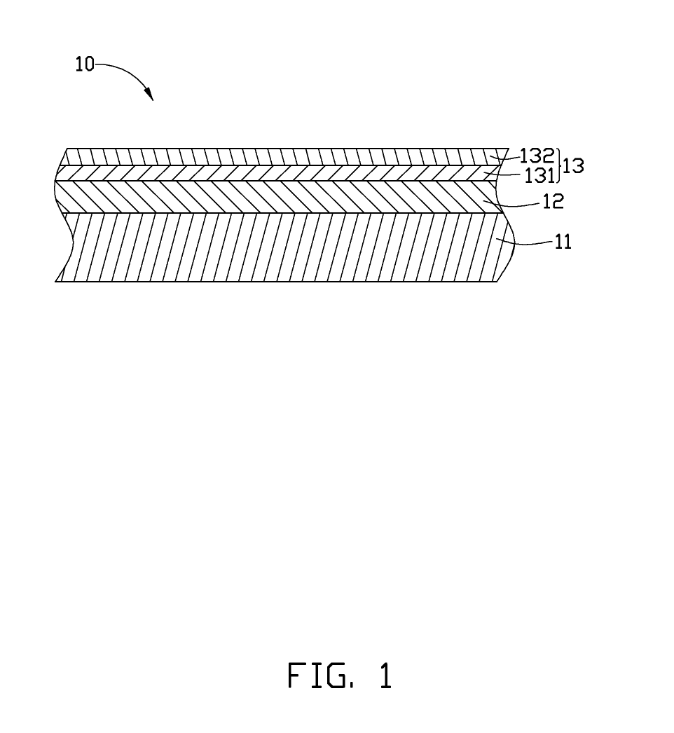

FIG. 1 shows an exemplary embodiment of a magnesium alloy article 10 such as a housing for a mobile phone. The magnesium alloy article 10 includes a base 11, an intermediate layer 12 formed on the base 11, and a coating layer 13 formed on the intermediate layer 12. A thickness of the intermediate layer 12 is in a range from about 0.2 um to about 5 μm. The intermediate layer 12 is a mixture of components containing elements selected from among magnesium (Mg), aluminum (Al), oxygen (O), phosphorus (P), and manganese (Mn). A total thickness of the coating layer 13 is in a range from about 2 μm to 5 μm. The coating layer 13 includes a first layer 131 and a second layer 132, each layer 131, 132 of thickness is from about 1 μm to 3 μm. The first layer 131 may be made of MgₓO_{y}N_{z} and is used to strengthen the bond of the second layer 132 with the intermediate layer 12. The second layer 132 is colored and serves as an exterior layer for the magnesium alloy article 10. The second layer 132 may be made of CrₓO_{y}N_{z}. The parameters x, y, z concerning MgₓO_{y}N_{z} and CrₓO_{y}N_{z} can be selected among integers 1-10.

A method for making the magnesium alloy article 10 includes following steps.

A base 11 is provided as being a magnesium alloy containing magnesium and aluminum. The base 11 may have some grease and tiny protrusions on the surface from punching or casting. It is necessary to clean the grease and remove the tiny protrusions from the base 11.

The base 11 is cleaned by a cleaning solution to clean grease on the surface of the base 11. The cleaning solution can be a mixture solution that contains sodium carbonate (Na₂CO₃), 12H₂O sodium phosphate (12H₂O.Na₃PO₄), octylphenol polyoxyethylene and H₂O, the Na₂CO₃, the Na₃PO₄ and the octylphenol polyoxyethylene having the weight concentration in a range of 25 g/l-30 g/l, 20 g/l-25 g/l, and 1 g/l-3 g/l, respectively. During cleaning, the base 11 is placed into the cleaning solution, the cleaning solution is at the temperature of about 60° C. to about 80° C. for about 30 seconds to about 60 seconds.

The base 11 can be further rinsed in water after the cleaning to remove any remaining cleaning solution on the surface of the base 11.

The base 11 is etched by a conventional etching solution after being washed in water to remove the tiny protrusions of the base 11. The etching solution can be prepared from sodium hydroxide (NaOH), sodium phosphate (Na₃PO₄), sodium carbonate (Na₂CO₃), sodium fluoride (NaF) and H₂O. The NaOH, the Na₃PO₄, the Na₂CO₃, and the NaF have the weight concentration in a range of 40 g/l-70 g/l, 10 g/l-20 g/l, 25 g/l-30 g/l and 40 g/l-50 g/l, respectively. During etching, the base 11 is placed into the etching solution, the etching solution at a temperature of 40° C.-50° C., for about 3 s-5 s. The tiny protrusions substantially contact and the chemical reacts with the etching solution, thus, the mini-protrusions can be eliminated completely, the surface of the base 11 is substantially flattened.

The base 11 is activated in an activating solution after the etching to strengthen the bonding of intermediate layer 12 and the base 11. The activating solution can be prepared from nitric acid (HNO₃), floric acid (HF), and H₂O. HNO₃ has a weight percentage of 1-10% of the entire solution, and HF has a weight percentage of 1-8% of the entire solution. The weight ratio between the HNO₃ and the HF can be 3:1. The base 11 is immersed into the activating solution at a room temperature for about 3 seconds to about 20 s.

The base 11 is processed by a conversion solution after activation to form the intermediate layer 12 on the surface of the base 11. The conversion solution can be prepared by ammonium di-hydrogen phosphate, potassium permanganate (KMnO₄), an additive, and H₂O. The additive includes an inorganic component of sulphide and an organic component of ammonia. The sulphide and the ammonia respectively have a weight percentage of 10-20% in the entire additive. The ammonium di-hydrogen phosphate has a weight concentration in a range of 60 g/l-100 g/l, the KMnO₄ has a weight concentration in a range of 1 g/l-40 g/l, and the additive has a weight concentration in a range of 1 g/l-6 g/l. The base 11 is placed into the conversion solution, the solution at a temperature of 30° C. for about 20 minutes. Thus, the surface of the base 11 has the intermediate layer 12 evenly formed thereon. The intermediate layer 12 has a thickness of 0.2 μm-5 μm, and the intermediate layer 12 is a mixture of components with Mg, Al, O, P, Mn having the atomic number ratio that Mg:Al:O:P:Mn=(1-5):(1-5):(2-10):(1-10):(3-10). The intermediate layer 12 is formed by chemical reactions among the elements Mn, P, O with the Mg, Al contained in the base 11. After processing by the conversion solution, the base 11 is taken out from conversion solution and dried.

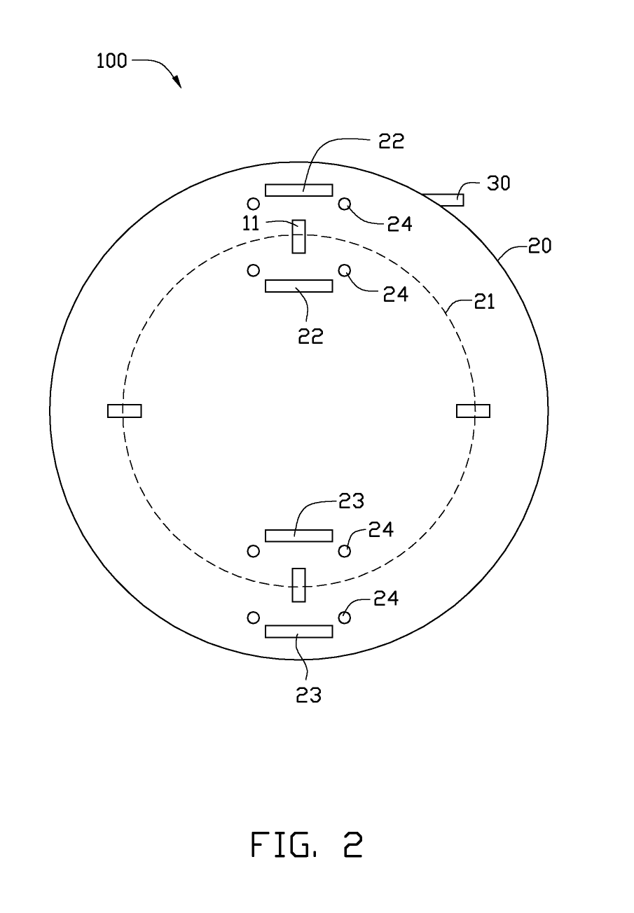

The base 11 is processed by PVD after forming of the intermediate layer 12 on the base 11 for forming the coating layer 13 on the intermediate layer 12. Referring to FIG. 2, the base 11 is placed into a vacuum sputtering coating machine 100. The vacuum sputtering coating machine 100 includes a sputtering coating chamber 20 and a vacuum pump 30 connecting to the sputtering coating chamber 20. The vacuum pump 30 is used to pump the air out the sputtering coating chamber 20. The vacuum sputtering coating machine 100 further includes a rotating bracket 21, two first targets 22, two second targets 23 and a plurality of gas inlets 24. The rotating bracket 21 rotates the substrate 11 in the sputtering coating chamber 20 relative to the first targets 22 and the second targets 23. The first targets 22 face each other, and are respectively located on opposite sides of the rotating bracket 21. The second targets 23 face each other, and are respectively located on opposite sides of the rotating bracket 21. In this exemplary embodiment, the first targets 22 can be made of simple Mg or Mg alloy. The second targets 23 are made of Chromium (Cr)

A coating layer 13 is deposited on the substrate 11. The vacuum level inside the sputtering coating chamber 20 is set to about 8.0×10⁻³ Pa. The temperature in the sputtering coating chamber 20 is set between about 100° C. (Celsius degree) and about 300° C. A bias voltage applied to the substrate 11 may be between about −150 volts and about −300 volts. Argon, Nitrogen and Oxygen are fed into the sputtering coating chamber 20 from the gas inlets 24, with Argon at a flux between about 1 Standard Cubic Centimeters per Second (sccs) and about 300 sccs, with Nitrogen at a flux between about 1 sccs and about 50 sccs, with Nitrogen and Oxygen at a flux between about 1 sccs and about 50 sccs. The speed of the rotating bracket is set about 0.5 revolutions per minute (rpm). The first targets 22 in the sputtering coating chamber 20 are evaporated at a power between about 8 kW and about 16 kW. After about 60 minutes, a first layer 131 is formed the intermediate layer 12 and mainly includes MgxOyNz. Then, the first targets 22 are turned off, the second targets 23 are turned on. The second targets 22 are loaded with a power 8˜16 Kilowatt (KW), and the rotating speed of the bracket 21 can be 0.5r/min. By sputtering about 60 minutes, a second layer 132 is formed on the first layer 131 and mainly includes CrₓO_{y}N_{z}. The second layer 132 bonding with the first layer 131 forms the coating layer 13 having a thickness of 2 μm-5 μm. The first layer 131 firmly attach to the intermediate layer 12 and the second layer 132, the second layer 131 is colored. Therefore, the magnesium alloy article 10 is manufactured.

Relative to the present magnesium alloy article 10, due to the intermediate layer 12, the coating layer 13 firmly bonds with the base 11. Additionally, the coating layer 13 has a sound hardness, and the magnesium alloy article 10 has sound abrasion resistance and corrosion resistance.

It is to be understood that even though numerous characteristics and advantages of the present embodiments have been set forth in the foregoing description, together with details of assemblies and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A magnesium alloy article, comprising:
a base made of magnesium alloy;
a coating layer formed on the base, and
an intermediate layer formed between the base and the coating layer,
wherein the intermediate layer is a mixture of components substantially comprising elements chosen from Mg, Al, O, P, Mn.

2. The magnesium alloy article as claimed in claim 1, wherein a thickness of the intermediate layer is in a range from about 0.2 μm to about 5 μm.

3. The magnesium alloy article as claimed in claim 1, wherein a thickness of the coating layer is in a range from about 2 μm to about 5 μm.

4. The magnesium alloy article as claimed in claim 1, wherein the intermediate layer includes compounds with Mg, Al, O, P, Mn having the atomic number ratio that Mg:Al:O:P:Mn=(1-5):(1-5):(2-10):(1-10):(3-10).

5. The magnesium alloy article as claimed in claim 1, wherein the coating layer includes a first layer and a second layer, the first layer includes a main component MgₓO_{y}N_{z}, the second layer is colored as an outer layer of the magnesium and includes a main component CrₓO_{y}N_{z}, the parameters x, y, z concerning MgₓO_{y}N_{z} or CrₓO_{y}N_{z} are selected among integers 1-10.

6. A method for making the magnesium alloy article, comprising:
providing a base made of magnesium alloy;
forming an intermediate layer on the base;
forming a coating layer on the intermediate layer.

7. The method for making the magnesium alloy article as claimed in claim 6, wherein further including cleaning the base by a cleaning solution to clean grease before forming the intermediate layer.

8. The method for making the magnesium alloy article as claimed in claim 7, wherein the cleaning solution can be a mixture solution that prepared form sodium carbonate (Na₂CO₃), sodium phosphate (Na₃PO₄), octylphenol-polyoxyethylene and H₂O.

9. The method for making the magnesium alloy article as claimed in claim 7, wherein further including etching the base by an etching solution to flatten the surface of the base during cleaning the grease and forming the intermediate layer.

10. The method for making the magnesium alloy article as claimed in claim 7, wherein the etching solution is a mixture solution that prepared form sodium hydroxide (NaOH), sodium phosphate (Na₃PO₄), sodium carbonate (Na₂CO₃), sodium fluoride (NaF) and H₂O.

11. The method for making the magnesium alloy article as claimed in claim 9, wherein further including activating the surface of the base by an activating solution after etching the base, to improve the intermediate layer bonding with the surface of the base.

12. The method for making the magnesium alloy article as claimed in claim 11, wherein the activating solution is a mixture solution and can be prepared by nitric acid (HNO₃), floric acid (HF), and H₂O.

13. The method for making the magnesium alloy article as claimed in claim 11, wherein to form the intermediate layer on the base by placing the base into a conversion solution.

14. The method for making the magnesium alloy article as claimed in claim 13, wherein the conversion solution is prepared by the ammonium di-hydrogen phosphate, the potassium permanganate (KMnO4), an addictive, and the H₂O.

15. The method for making the magnesium alloy article as claimed in claim 14, wherein the addictive includes an inorganic component of sulphide and an organic component of ammonia system, the sulphide and the ammonia system respectively has a weight percentage 10-20% in the integral addictive.

16. The method for making the magnesium alloy article as claimed in claim 7, wherein the intermediate layer includes elements Mg, Al, O, P, Mn, the atomic number ratio that Mg:Al:O:P:Mn=(1-5):(1-5):(2-10):(1-10):(3-10).

17. The method for making the magnesium alloy article as claimed in claim 6, wherein coating layer includes a first layer and a second layer, the first layer includes a main component MgₓO_{y}N_{z}, the second layer is colored as an outer layer of the magnesium and includes a main component CrₓO_{y}N_{z}, the parameters x, y, z concerning MgₓO_{y}N_{z} or CrₓO_{y}N_{z} are selected among integers 1-10.
